(19) United States
(12) Patent Application Publication
(10) Pub. No.: US 2018/0287887 A1
(43) Pub. Date: Oct. 4, 2018

(54) PROVIDING MEMBERS OF A USER GROUP WITH ACCESS TO RESTRICTED MEDIA CONTENT ITEMS

(71) Applicant: Google Inc., Mountain View, CA (US)

(72) Inventors: Justin Lewis, Marina Del Rey, CA (US); Ruxandra Georgiana Paun, Santa Monica, CA (US)

(73) Assignee: Google Inc., Mountain View, CA (US)

(21) Appl. No.: 14/046,079

(22) Filed: Oct. 4, 2013

(51) Int. Cl. H04L 12/24

(52) U.S. Cl. CPC H04L 41/50

(57) ABSTRACT

Systems and methods are disclosed for providing members of a user group with access to restricted media content items. In one implementation, a processing device receives selections of one or more substantially unrestricted media content items, the one or more substantially unrestricted media content items being associated with a media content provider and being accessible to one or more users of a media sharing service. The processing device processes the selections to identify one or more users with respect to which at least one of the one or more selections originated, generates one or more groups, each of the groups including at least one of the users, and provides, to at least one of the one or more groups, access to one or more restricted media content items, the one or more restricted media content items being inaccessible to one or more users of the media sharing service.

### TECHNICAL FIELD

Aspects and implementations of the present disclosure relate to data processing, and more specifically, to providing members of a user group with access to restricted media content items.

### BACKGROUND

Audio and video content can be stored on data servers and provided to users for listening/viewing over the Internet. Applications for supporting the listening/viewing of such audio and video content may be browser-based, or may run independently of a browser.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device receives one or more selections of one or more substantially unrestricted media content items, the one or more substantially unrestricted media content items being associated with a media content provider and being accessible to one or more users of a media sharing service. The processing device processes the one or more selections to identify one or more users with respect to which at least one of the one or more selections originated. The processing device generates one or more groups, each of the one or more groups comprising at least one of the one or more users. The processing device provides, to at least one of the one or more groups, access to one or more restricted media content items, the one or more restricted media content items being inaccessible to one or more users of the media sharing service.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts a flow diagram of aspects of a method for providing members of a user group with access to restricted media content items.

FIG. 3A depicts an exemplary scenario in which several users have been identified as ‘Top Viewers,’ in accordance with one implementation of the present disclosure.

FIG. 3B depicts an exemplary scenario in which several users have been identified as ‘Top Sharers,’ in accordance with one implementation of the present disclosure.

FIG. 3C depicts an exemplary scenario in which several users have been identified as ‘Top Sharers,’ in accordance with one implementation of the present disclosure.

FIG. 4 depicts an exemplary suggested designation of one or more restricted media content items, in accordance with one implementation of the present disclosure.

FIG. 5 depicts an exemplary notification informing a user of promotional access to a restricted media content item, in accordance with one implementation of the present disclosure.

FIG. 6 depicts a block diagram of an illustrative computer system operating in accordance with aspects and implementations of the present disclosure.

### DETAILED DESCRIPTION

Aspects and implementations of the present disclosure are directed to providing members of a user group with access to restricted media content items. The systems and methods disclosed can be applied to media content such as audio and/or video content, images, and/or any other content that can be collected and/or disseminated such as via a media sharing service or website. More particularly, while content creators and providers (also referred to as “content curators” such as individuals/entities that provide media content to media sharing services) invest considerable efforts in creating/providing media content, in many cases other users, such as ‘followers’ or ‘fans’ of such media content creators/providers can make substantial contributions to the successful dissemination of such media content items. For example, many users who enjoy/appreciate the media content provided by a particular media content provider may return regularly to a page or ‘channel’ associated with such a content provider, to view new or additional media content provided by the content provider. By way of further example, other users who enjoy/appreciate the media content provided by a particular media content provider may ‘share’ or otherwise disseminate such media content items (e.g., by posting a link to or embedding the media content item with a social networking page or site, by forwarding a link to others via email, etc.).

While such users (e.g., users who regularly view and/or share media content provided by a particular media content provider) can make significant contributions to the overall viewership of media content provided by a particular media content provider, various privacy considerations and terms of use associated with media sharing services dictate that the identities/contact information associated with such users should not be made available to the media content provider. As such, while a media content provider may wish to reward and/or incentivize such users, the referenced privacy considerations make doing so much more difficult.

Accordingly, described herein in various embodiments are technologies that enable access to restricted media content items to be provided to members of a user group. That is, it can be appreciated that in addition to content items that, under most circumstances, are provided for access to most/all users via the media sharing service, many content providers also maintain ‘restricted’ media content items that are inaccessible, under most circumstances, to many/most users of the media sharing service. Examples of such restricted media content items include, but are not limited to, ‘premium’ content which can be accessed by a user upon paying an additional fee or acquiring a subscription, ‘unreleased’ content which the media content provider has decided to maintain as ‘unreleased’ or otherwise inaccessible to other users, and/or any other such exclusive content that is not available to most/all users. Accordingly, as described herein, users identified as being among those achieving a particular status with respect to the media content items provided by a particular media content provider (e.g., being among the highest viewing and/or highest sharing users) can be included in a corresponding user group. The media content provider can designate and provide such a group (that is, the users included in such a group) with access to one or more of the referenced restricted media content items. In doing so, the media sharing service can, for example, enable a media content provider provide promotional access to restricted media content item(s) to certain users (e.g., ‘top viewers,’ ‘top sharers,’ etc.) without providing such media content providers with identifying information and/or any actual contact information (e.g., user ID, email address, etc.) associated with individual user(s). In doing so, the media sharing service can enable a media content provider to provide selective access to restricted content items to a particular group of users, while also ensuring that the identity and privacy of the individual users is not revealed or compromised.

For example, the media sharing service can allow a content provider to reward most prolific sharers and/or top viewers of the content provider's videos with a video that is not available to other users. For example, a channel curator can syndicate a private video to the top 10% of sharers of the channel curator's videos. As a result, these users will receive a reward (the syndicated private video) for their prolific sharing. In another example, a channel curator can syndicate a private video or message to the users who have watched the majority of the channel curator's recent videos.

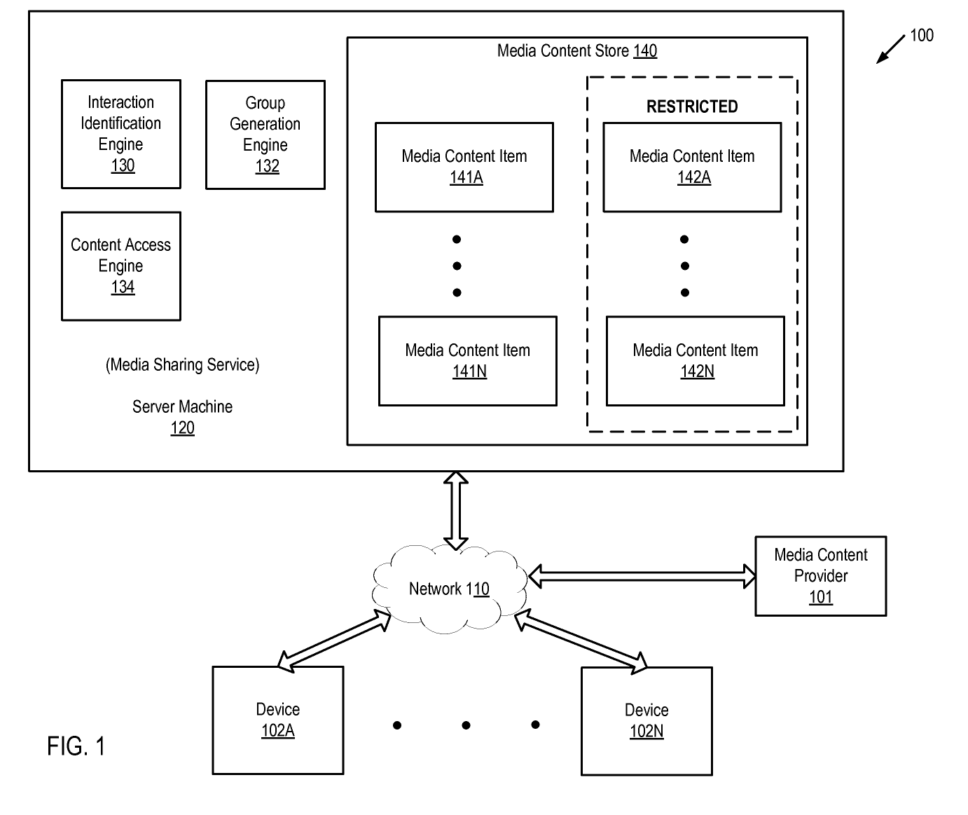

FIG. 1 depicts an illustrative system architecture 100, in accordance with one implementation of the present disclosure. The system architecture 100 includes media content provider device 101, user devices 102A-102N and server machine 120. These various elements or components can be connected to one another via network 110, which can be a public network (e.g., the Internet), a private network (e.g., a local area network (LAN) or wide area network (WAN)), or a combination thereof.

Media content provider device 101 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. In certain implementations, media content provider device 101 can enable a media content creator, such as a user or entity that creates media content (e.g., audio, video, images, etc.) to provide (e.g., upload) such media content items to a server machine (e.g., server machine 120), such as a server configured as a media sharing service that can allow other users to view or otherwise acquire/obtain access to the provided media content items via the service.

User devices 102A-102N can be wireless terminals (e.g., smartphones, etc.), personal computers (PC), laptops, tablet computers, or any other computing or communication devices. The user devices 102A-102N may run an operating system (OS) that manages hardware and software of the user devices 102A-102N. Various applications, such as mobile applications (‘apps’), web browsers, etc. (not shown) may run on the client machines (e.g., on the OS of the client machines). Such applications can, for example, enable a user to capture media content (e.g., an audio clip, a video clip, etc.), provide media content (e.g., upload media content to a central server and/or transmit it to another user), receive media content (e.g., via network 110), and/or view, display, or otherwise present media content (e.g., playing a video, listening to a song, etc.), such as via the user device 102. The user devices 102A-102N can be geographically distributed anywhere throughout the world.

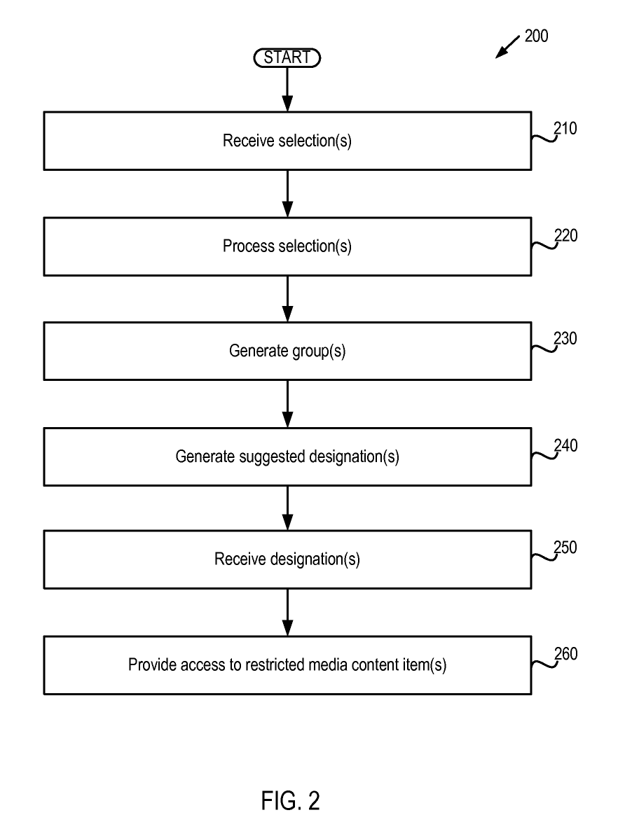

Server machine 120 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. Server machine 120 can include components such as interaction identification engine 130, group generation engine 132, content access engine 134, and media content store 140. The components can be combined together or separated in further components, according to a particular implementation. It should be noted that in some implementations, various components of server machine 120 may run on separate machines. Moreover, some operations of certain of the components are described in more detail below with respect to FIG. 2.

Media content store 140 can be hosted by one or more storage devices, such as main memory, magnetic or optical storage based disks, tapes or hard drives, NAS, SAN, and so forth. In some implementations, media content store 140 can be a network-attached file server, while in other implementations media content store 140 can be some other type of persistent storage such as an object-oriented database, a relational database, and so forth, that may be hosted by the server machine 120 or one or more different machines coupled to the server machine 120 via the network 110, while in yet other implementations media content store 140 may be a database that is hosted by another entity and made accessible to server machine 120.

Media content store 140 can include media content items 141A-141N. In certain implementations, media content items 141A-141N can correspond to media content itself (e.g., audio clips, video clips, images, etc.) and can be provided, for example, by a media content provider. Moreover, in certain implementations, server machine 120 can be configured to allow full and/or substantially unlimited access to such media content items. Accordingly, users wishing to access or view such media content items via the media sharing service can be enabled, under most circumstances, to do so.

In certain implementations, media content store 140 can also include restricted media content items 142A-142N. In contrast to media content items 141A-N (which, as noted, are, under most circumstances, accessible to all users via the media sharing service), restricted media content items 142A-142N can correspond to media content items that have been designated, such as by the media content provider, as being inaccessible, under most circumstances, to many/most users of the media sharing service. For example, in certain implementations, such restricted media content items 142A-N can correspond to ‘premium’ content which can be accessed by a user upon paying an additional fee. By way of further example, in certain implementations, such restricted media content items 142A-N can correspond to ‘unreleased’ content which, though stored in media content store 140, the media content provider has decided to maintain as ‘unreleased’ or otherwise inaccessible to other users.

As described herein, one or more selections of media content items 141 can be processed and/or analyzed, such as in order to identify various users with respect to such selections occur. In certain implementations, such operations can be performed by and/or in conjunction with interaction identification engine 130. In doing so, one or more groups of such users can be generated, such as by and/or in conjunction with group generation engine 132. Moreover, in certain implementations, access to one or more restricted media content items 142 can be provided to such groups (e.g., to one or more users included in such groups), such as by and/or in conjunction with content access engine 134, as described herein.

It should be noted that in situations in which the systems discussed herein collect personal information about users, or may make use of personal information, the users may be provided with an opportunity to control whether programs or features collect user information (e.g., information about a user's media viewing history, interests, a user's preferences, or a user's current location), or to control whether and/or how to receive content that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

FIG. 2 depicts a flow diagram of aspects of a method 200 for providing members of a user group with access to restricted media content items. The method is performed by processing logic that may comprise hardware (circuitry, dedicated logic, etc.), software (such as is run on a general purpose computer system or a dedicated machine), or a combination of both. In one implementation, the method is performed by server machine 120 of FIG. 1, while in some other implementations, one or more blocks of FIG. 2 may be performed by another machine. For example, in various alternative implementations, the method can be performed at media content provider 101 and/or a user device 102 (i.e., the method or various aspects thereof can be performed locally at the media content provider 101 and/or device 102 rather than in communication with a server such as server machine 120).

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 210 one or more selections of one or more media content items can be received. For example, such selections can correspond to viewing instances, such as of a media content item 141 (e.g., a video) via a streaming media service. By way of further example, such selections can correspond to one or more instances of media consumption, such as instances of downloading or otherwise acquiring or obtaining access to a media content item. In certain implementations, such media content items can be associated with a media content provider 101, such as a media content creator that provides (e.g., uploads) media content items (e.g., videos) to a media sharing service, such that users can view or otherwise acquire/obtain access to the provided media content items via the service. Moreover, in certain implementations, such media content items can be substantially unrestricted, in that they are accessible to a number of users (e.g., many, most, or substantially all) of the media sharing service. In one aspect, block 210 is performed by interaction identification engine 130.

At block 220, one or more selections (such as the selections received at block 210) can be processed. In doing so, one or more users can be identified. For example, in certain implementations users with respect to which at least one of the one or more selections (such as those selections received at block 210) originated can be identified. That is, it can be appreciated that various selections of a media content item (e.g., instances of viewing of a video via a media sharing service) can be associated with particular users (as reflected, for example, by a user account, identifier, or other such characteristic in relation to which a user accesses the media sharing service). Accordingly, the user or users that, for example, view or otherwise select one or more particular media content items can be identified. As noted above, in various implementations, such as those in which identifying or personal information about users is utilized, such users may be provided with an opportunity to control whether programs or features collect user information. In one aspect, block 220 is performed by interaction identification engine 130.

By way of further example, in certain implementations users attributed with dissemination of one or more media content items (such as those in relation to which one or more selections were received, such as at block 210) can be identified. That is, in certain implementations, the dissemination of a media content item can be attributed to one or more users who ‘share’ the media content item (e.g., provide access to the media content item itself and/or a link to it in one or more contexts such as within a social networking service or website) with one or more other users (who can then select/view the shared media content item). In doing so, while one user may view a media content item, another user can be attributed with dissemination of the media content item to the viewing user (e.g., by ‘sharing’ a link to the media content item, such as a hyperlink that incorporates an encrypted element that can be processed to identify the identity of the sharing user). Accordingly, it can be appreciated that, for example, a single user can be attributed with the dissemination of a single media content item to multiple other users, such as by proving a hyperlink to the media content item that is selected by such multiple users. As noted above, in various implementations, such as those in which identifying or personal information about users is utilized, such users may be provided with an opportunity to control whether programs or features collect user information.

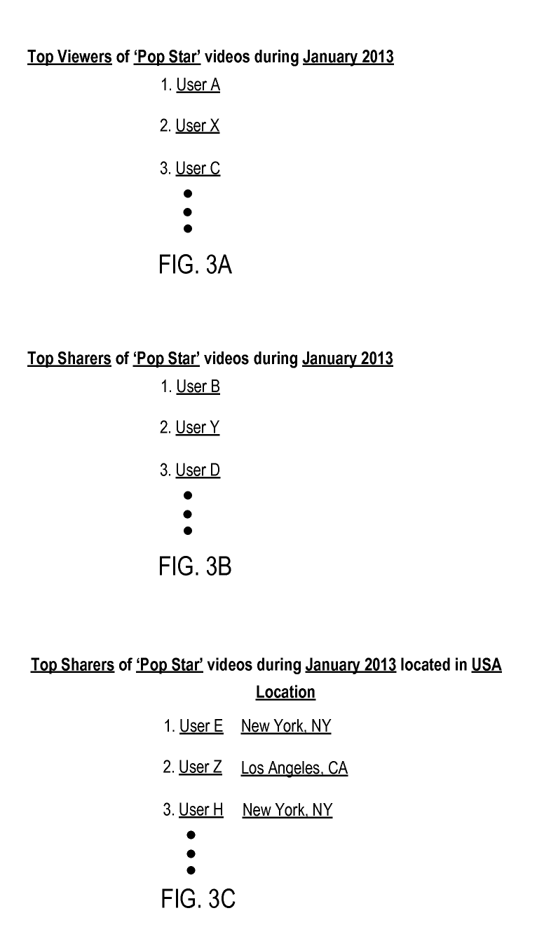

At block 230, one or more groups can be generated. In certain implementations, each of the one or more groups can include one or more users (such as those users identified at block 220). For example, a group can be identified with respect to one or more aspects associated with those users that have selected one or more particular media content items. By way of illustration, a group can be generated to include those users that have viewed at least a certain number of media content items that have been provided by a media content curator to a media sharing service (e.g., at least 60% of the media content items provided by a media content creator). By way of further illustration, a group can be generated to include the 25 users that have viewed the greatest number of media content items that provided by a media content curator to a media sharing service (e.g., over a particular timeframe, such as the previous week). It should be understood, however, that such definitions are exemplary and that the referenced groups can be generated based on any number of criteria. By way of illustration, FIG. 3A depicts an exemplary scenario showing several users identified as having viewed the greatest number of ‘Pop Star’ videos (e.g., videos provided by a media content provider associated with ‘Pop Star’) during January 2013. In one aspect, block 230 is performed by group generation engine 132.

Moreover, in certain implementations a group can be generated that includes users (such as those identified at block 220) attributed with dissemination of one or more media content items (as determined, for example, based on selections of a media content item, such as those received at block 210, that can be attributed to an instance of ‘sharing’ of the media content item by a user, as described herein). By way of illustration, a group can be generated to include those users attributed with dissemination of at least a certain number of media content items that have been provided by a media content creator to a media sharing service above a defined dissemination threshold (e.g., ‘sharing’ on a social networking service at least 60% of the media content items provided by a media content curator). By way of further illustration, a group can be generated to include the 25 users whose respective dissemination(s) (e.g., instances of ‘sharing’) of one or more media content items have resulted in the greatest number of subsequent selections/views (e.g., over a particular timeframe, such as the previous week). It should be understood, however, that such definitions are exemplary and that the referenced groups can be generated based on any number of criteria. By way of illustration, FIG. 3B depicts an exemplary scenario showing several users identified as having shared the greatest number of ‘Pop Star’ videos (e.g., videos provided by a media content provider associated with the ‘Pop Star’) during January 2013.

Additionally, in certain implementations a group can be generated that includes users (such as those identified at block 220) associated with one or more characteristics. For example, a group can be generated from among the users identified at block 220, such as those users having one or more characteristics, attributes, and/or associations (e.g., having one or more particular interests, being associated with a particular demographic, geographic location, etc.). By way of illustration, FIG. 3C depicts an exemplary scenario showing several users identified as both being located within the United States and as having shared the greatest number of ‘Pop Star’ videos (e.g., videos provided by a media content provider associated with the ‘Pop Star’) during January 2013.

At block 240, a suggested designation of the one or more restricted media content items can be generated. In certain implementations, the suggested designation can be generated based on one or more characteristics associated with the at least one of the one or more groups (such as those generated at block 230). That is, having generated one or more groups of users, such as a group of ‘top viewers’ (reflecting, for example, that such users viewed the greatest number of media content items provided by the content provider) and/or ‘top sharers’ (reflecting, for example, that such users shared one or more media content items provided by the content provider the greatest number of times), a suggested designation of one or more restricted media content items can be generated, such as based on one or more characteristics that some (or all) of the users within the generated group share. In generating such a suggested designation, the content provider can be provided with one (or more) suggestion(s) of particular restricted media content items that may be of interest to some (or all) of the users within the referenced group(s). In one aspect, block 240 is performed by content access engine 134.

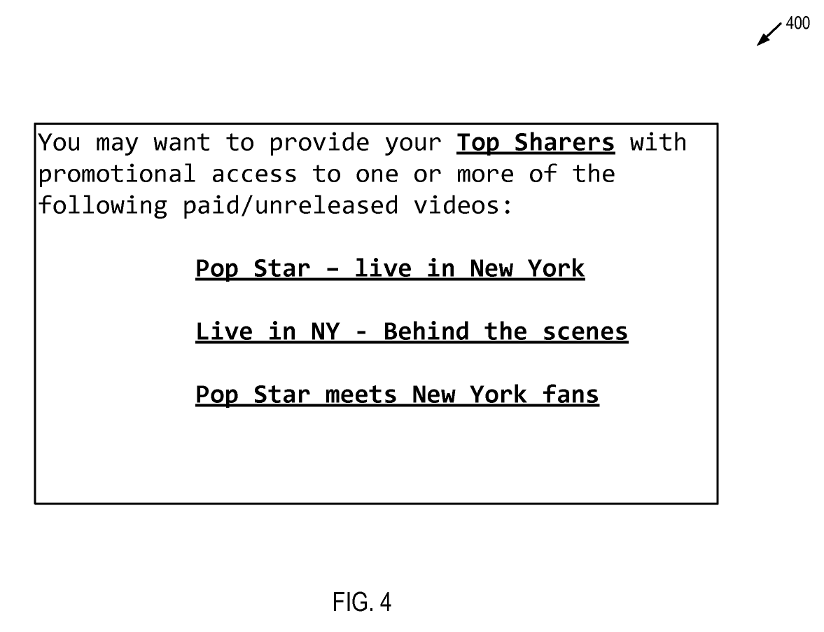

By way of illustration, it can be appreciated with respect to FIG. 3C that a number of the users identified as being among the ‘top sharers’ in the USA have a common characteristic of being located in New York, N.Y. Accordingly, as shown in FIG. 4, a suggested designation 400 of one or more restricted media content items can be generated based on such a common characteristic. For example, one or more restricted media content items 142 that can be identified as being associated with the same location (‘New York, N.Y.,’ as can be determined, for example, based on the title of the media content item, one or more tags or categories associated with the media content item, a geolocation associated with the media content item when captured, etc.) can be suggested to the media content provider as content item(s) that may be of particular interest to some or all of the users that make up the ‘top sharers’ group.

At block 250, a designation of the one or more restricted media content items can be received. In certain implementations, such a designation can be received from the media content provider. That is, having generated (such as at block 240) a suggested designation of one or more restricted media content items, an actual designation (selecting one or more of such suggestions) can be received, such as from the media content provider. It should be noted that, in certain implementations, the media content provider can provide one or more of such designations independent of any such suggestions (e.g., the media content provider can select one or more restricted media content items 142 irrespective of those with respect to which such suggestions were generated). Moreover, in certain implementations the referenced suggestions may not be generated, and the media content provider can simply select from among restricted media content items. In one aspect, block 250 is performed by content access engine 134.

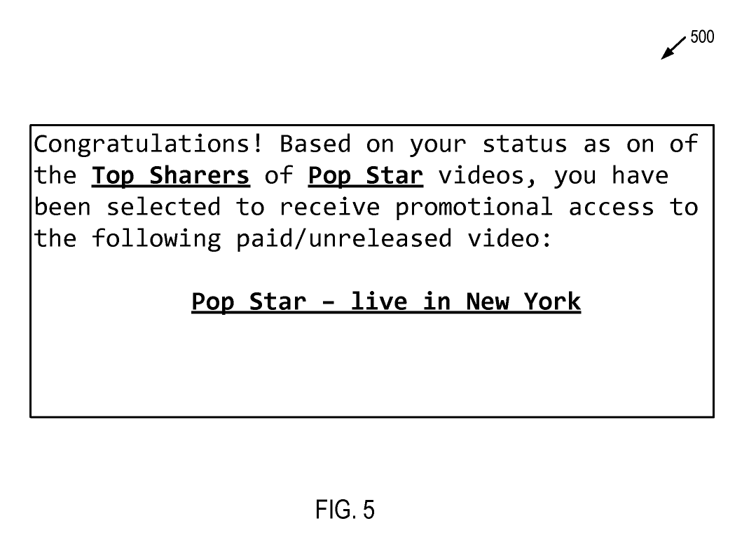

At block 260, access to one or more restricted media content items can be provided. In certain implementations, such access can be provided one or more groups, such as those generated at block 230. That is, having received a designation of the one or more restricted media content items (such as at block 250), access to such designated items can be provided to one or more particular groups of users. Moreover, in certain implementations such access can be provided to the one or more groups (such as those generated at block 230) prior to the access to the restricted media content items being provided to one or more other users. Additionally, in certain implementations a notification of the access to one or more restricted media content items can be provided to the one or more users. By way of illustration, FIG. 5 depicts an exemplary scenario showing a notification that can be provided to users identified as being ‘top sharers’ of ‘Pop Star’ videos, indicating a restricted media content item 142 that such a user has been provided access to by virtue of being included in the ‘top sharers’ group. In one aspect, block 260 is performed by content access engine 134.

At this juncture, it should be noted that, in certain implementations, the media content provider 101 (e.g., the media content provider associated with the ‘Pop Star’ media content items, as depicted in FIGS. 3A-5) can designate and provide access to one or more restricted media content items 142 by identifying one or more particular groups of users (e.g., those groups generated at block 230, such as ‘top viewers,’ ‘top sharers,’ etc.). That is, it can be appreciated that it can be advantageous (such as for a media sharing service) to enable a media content provider to transmit notifications (e.g., a notification 500 as depicted in FIG. 5, informing a user of promotional access to a restricted media content item) to certain users (e.g., users among the ‘top viewers’ or ‘top sharers’ of media content items associated with the media content provider) without providing such media content providers with identifying information and/or any actual contact information (e.g., user ID, email address, etc.) associated with individual user(s). Accordingly, as described herein, the media content provider can designate that such communications, notifications, etc. (pertaining, for example, to promotional access being provided to various restricted content items) be provided to one or more particular groups of users (e.g., ‘top sharers,’ ‘top viewers,’ etc.), and the media sharing service can then coordinate dissemination of such communications, notifications, etc., to the individual users included in such a group, while precluding the media content provider from having access to any such identifying information. In doing so, the media sharing service can enable a media content provider to provide selective access to restricted content items to a particular group of users, while also ensuring that the identity and privacy of the individual users is not revealed or compromised.

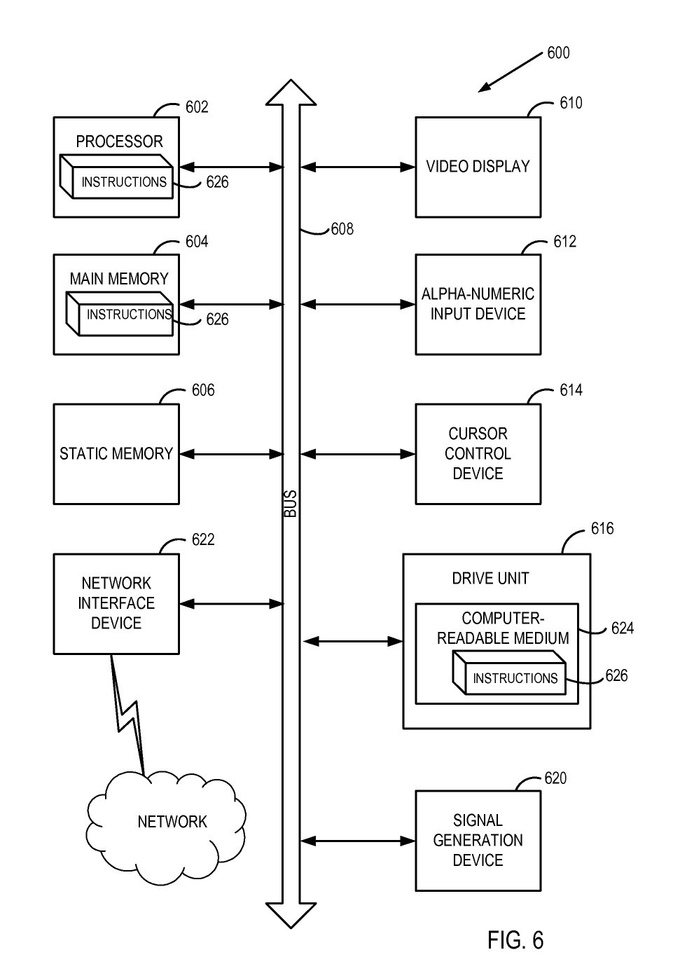

FIG. 6 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by collaboration manager 225, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “determining,” “initiating,” “comparing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

1. A computer-implemented method comprising:
receiving selections of unrestricted media content items of a media content provider, the unrestricted media content items being accessible to a plurality of users of a media sharing service, each selection of an unrestricted media content item being performed by a viewing user with whom the unrestricted media content item was shared by a sharing user, wherein each unrestricted media content item has a tag identifying a respective sharing user;
processing, with a processing device, the selections based on tags of the unrestricted media content items to identify a set of sharing users from the plurality of users that shared the unrestricted media content items of the media content provider with respective viewing users;
determining, for each sharing user of the set of sharing users, whether a number of two or more selections of unrestricted media content items shared by a respective sharing user satisfies a threshold condition pertaining to dissemination of respective unrestricted media content items of the media content provider among the plurality of users of the media sharing service over a specified timeframe;
generating one or more groups, each of the one or more groups comprising at least one sharing user of the set of sharing users that shared unrestricted media content items with the number of selections that satisfies the threshold condition pertaining to the dissemination of the unrestricted media content items of the media content provider, wherein each of the one or more groups is assigned a unique group identifier to identify a respective group without revealing identities of members of the respective group;
wherein the identities of members of the respective group comprises at least one of a computer user account associated with the media sharing service, an identifier associated with a user of the media sharing service, or computer user attributes associated with the media sharing service; and
providing, using unique group identifiers assigned to the one or more groups, access to one or more restricted media content items of the media content provider to members of the one or more groups, without revealing identities of the members of the one or more groups to the media content provider, the one or more restricted media content items being inaccessible to one or more users of the plurality of users of the media sharing service.

2. The method of claim 1, wherein processing the selections comprises identifying the set of sharing users attributed with dissemination of at least one of the unrestricted media content items.

3. The method of claim 2, wherein generating the one or more groups comprises generating a group comprising at least one sharing user of the set of sharing users attributed with dissemination of at least one of the unrestricted media content items above a defined dissemination threshold according to the threshold condition.

4. The method of claim 1, wherein the at least one sharing user of the set of sharing users are associated with one or more characteristics.

5. The method of claim 1, wherein providing, to the one or more groups, access to one or more restricted media content items comprises providing to the one or more groups, access to the one or more restricted media content items prior to providing access to the one or more restricted media content items to one or more other users of the plurality of users of the media sharing service.

6. The method of claim 1, wherein providing, to the one or more groups, access to one or more restricted media content items comprises providing, to the set of users, a notification of the access to one or more restricted media content items.

7. The method of claim 1, further comprising receiving, from the media content provider, a designation of the one or more restricted media content items.

8. The method of claim 1, further comprising generating a suggested designation of the one or more restricted media content items.

9. The method of claim 8, wherein the suggested designation is generated based on one or more characteristics associated with the one or more groups.

10. A system comprising:
a memory; and
a processing device, coupled to the memory, to:
receive selections of unrestricted media content items of a media content provider, the unrestricted media content items being accessible to a plurality of users of a media sharing service, each selection of an unrestricted media content item being performed by a viewing user with whom the unrestricted media content item was shared by a sharing user, wherein each unrestricted media content item has a tag identifying a respective sharing user;
process the selections based on tags of the unrestricted media content items to identify a set of sharing users from the plurality of users that shared the unrestricted media content items of the media content provider with respective viewing users;
determine, for each sharing user of the set of sharing users, whether a number of two or more selections of unrestricted media content items shared by a respective sharing user satisfies a threshold condition pertaining to dissemination of respective unrestricted media content items of the media content provider among the plurality of users of the media sharing service over a specified time frame;
generate one or more groups, each of the one or more groups comprising at least one sharing user of the set of sharing users that shared unrestricted media content items with the number of selections that satisfies the threshold condition pertaining to the dissemination of the unrestricted media content items of the media content provider, wherein each of the one or more groups is assigned a unique group identifier to identify a respective group without revealing identities of members of the respective group;
wherein the identities of members of the respective group comprises at least one of a computer user account associated with the media sharing service, an identifier associated with a user of the media sharing service, or computer user attributes associated with the media sharing service; and
provide, using unique group identifiers assigned to the one or more groups, access to one or more restricted media content items of the media content provider to members of the one or more groups, without revealing identities of the members of the one or more groups to the media content provider, the one or more restricted media content items being inaccessible to one or more users of the plurality of users of the media sharing service.

11. The system of claim 10, wherein to process the selections is to identify the set of sharing users attributed with dissemination of at least one of the unrestricted media content items.

12. The system of claim 11, wherein to generate the one or more groups comprising at least one sharing user of the set of sharing users attributed with dissemination of at least one of the unrestricted media content items above a defined dissemination threshold according to the threshold condition.

13. The system of claim 10, wherein the at least one sharing user of the set of sharing users are associated with one or more characteristics.

14. The system of claim 10, wherein to provide, to the one or more groups, access to one or more restricted media content items is to provide to the one or more groups, access to the one or more restricted media content items prior to providing access to the one or more restricted media content items to one or more other users of the plurality of users of the media sharing service.

15. The system of claim 10, wherein to provide, to the one or more groups, access to one or more restricted media content items is to provide, to the set of users, a notification of the access to one or more restricted media content items.

16. The system of claim 10, wherein the processing device is further to receive, from the media content provider, a designation of the one or more restricted media content items.

17. The system of claim 10, wherein the processing device is further to generate a suggested designation of the one or more restricted media content items.

18. The system of claim 17, wherein the suggested designation is generated based on one or more characteristics associated with the one or more groups.

19. A non-transitory computer readable medium having instructions stored thereon that, when executed by a processor, cause the processor to perform operations comprising:
providing, to a media content provider, a suggested designation of one or more restricted media content items of the media content provider, the one or more restricted media content items of the media content provider being inaccessible to one or more users of a plurality of users of a media sharing service;
receiving, from the media content provider, a designation of the one or more restricted media content items of the media content provider;
identifying one or more groups comprising a set of sharing users of the plurality of users with respect to which selections of unrestricted media content items of the media content provider were shared, wherein each selection of an unrestricted media content item being performed by a viewing user with whom the unrestricted media content item was shared by a sharing user and each unrestricted media content item has a tag identifying a respective sharing user, and wherein each of the one or more groups is assigned a unique group identifier to identify a respective group without revealing identities of members of the respective group;
wherein the identities of members of the respective group comprises at least one of a computer user account associated with the media sharing service, an identifier associated with a user of the media sharing service, or computer user attributes associated with the media sharing service;
determining, for each sharing user of the set of sharing users, whether a number of two or more of the selections of the unrestricted media content items of the media content provider shared by a respective sharing user satisfies a threshold condition pertaining to dissemination of respective unrestricted media content items among the plurality of users of the media sharing service over a specified timeframe; and
based on the designation, providing, using unique group identifiers assigned to the one or more groups, access to the one or more restricted media content items of the media content provider to members of the one or more groups, without revealing identities of the set of sharing users to the media content provider.

20. The computer readable medium of claim 19, wherein the suggested designation is generated based on one or more characteristics associated with at least one of the one or more groups.
